(19) United States
(12) Patent Application Publication
(10) Pub. No.: US 2026/0145436 A1
(43) Pub. Date: May 28, 2026

(54) METHOD AND SYSTEM FOR REMOVING AIR BUBBLES FROM PRINTHEAD INK SUPPLY

(71) Applicant: Xerox Corporation, Norwalk, CT (US)

(72) Inventors: Peter Gulvin, Webster, NY (US); Christine A. Steurrys, Williamson, NY (US); Jorge Alvarez, Webster, NY (US); Seemit Praharaj, Marlborough, NH (US); Jason M. LeFevre, Penfield, NY (US); Varun Sambhy, Pittsford, NY (US); Anthony Condello, Webster, NY (US); Mark Petropoulos, Webster, NY (US); Douglas K. Herrmann, Webster, NY (US)

(21) Appl. No.: 18/962,070

(22) Filed: Nov. 27, 2024

(51) Int. Cl. B41J 2/19; B41J 2/17; B41J 2/175

(52) U.S. Cl. CPC B41J 2/19; B41J 2/1742; B41J 2/17596

(57) ABSTRACT

This document describes a method of removing air from an ink supply of a marking system, and systems that enable such removal. The system includes a valve that is fluidly connected to an ink supply system of a marking system. The valve is fluidly positioned in a conduit that leads from an opening in a conduit of the ink supply system to an air bubble reservoir. Activating the valve withdraws air from ink in the conduit toward an air bubble reservoir or vacuum source as the ink moves toward a printhead of the marking system.

### BACKGROUND

In inkjet printers, printheads include an arrangement of nozzles that eject ink onto a substrate. Printheads include or are associated with ink delivery systems, ink tubes, pumps, valves, and other various components to that transport ink to the printhead and remove waste ink away from the printhead.

In inkjet printing, supplying ink at the proper pressure, and without air bubbles entering the ink supply, can be challenging. Air bubbles can cause printhead nozzles to become blocked and fail to eject ink, which is a phenomenon sometimes referred to as a “missing nozzle” condition. Air bubbles can be caused by a leaky air fitting in the printer's ink supply or waste system, by air diffusion through tubing walls, by air ingestion through the nozzles, and/or by other causes. To address this, printers are sometimes programmed to perform a purge process in which ink is flushed through the system at high pressure.

When air bubbles form on the ink supply side, the air bubbles rise and build up at the apex of the tubing. If the bubbles are small, the purge process may sometimes simply pass ink by the bubbles, and the bubbles stay put unless or until they grow large enough to block substantially the whole tube diameter, in which case they can be pushed down the tube and into the head.

When air bubbles form in the printer's ink waste system, it can also cause issues. Because the waste tank is positioned to be higher than the printhead and the supply tank, if the valve to the waste tank leaks or gets stuck open, the ink tends all drain through the head back to the supply tank. In this process, air bubbles from the waste system can be pulled into back into the printhead. If the air bubbles persist and more nozzles are affected, issues with the quality of images can occur.

As printing systems improve, the systems can address some sources of air bubbles. However, getting rid of air bubbles entirely has proved challenging and impractical. In addition, as tubing of ink delivery and waste systems ages, chemical interactions and mechanical stresses can cause leaks in the tubing or at fitting locations.

Current methods of addressing these issues are limited. Software routines and control systems can sometimes purge or otherwise flush bubbles from the system. However, these processes do not always work, and typically they can only be performed on a single printhead, rather than multiple printheads at once. Alternatively, a service technician may be required to disassemble the printer and components of the printhead ink delivery system to resolve such issues. However, this is a time-consuming and tedious process that requires disassembling the printer and the pumps contained in the ink delivery system

The present disclosure relates to improvements that address at least some of the limitations and issues described above.

### SUMMARY

This document describes a method of removing air from an ink supply of a marking system. The method includes activating a valve that is fluidly connected to an ink supply system of a marking system. The valve is fluidly positioned in a conduit that leads from an opening in a conduit of the ink supply system to an air bubble reservoir. Activating the valve withdraws air from ink in the conduit as the ink moves toward a printhead of the marking system.

This document also describes a marking system that includes a printhead comprising a plurality of nozzles configured to eject ink from the printhead onto a substrate, as well as an ink supply system configured to supply ink to the printhead. The ink supply system includes an ink supply reservoir configured to hold the ink for delivery to the printhead. The marking system also includes a first conduit comprising a first end fluidly connected to a bottom section of the ink reservoir, a second end fluidly connected to the printhead, and an intermediate segment that (a) fluidly connects the first end and the second end, and (b) has an apex that is positioned above the printhead. The apex is fluidly connected to an exhaust conduit that is configured and positioned to, during operation, receive air from the ink and convey the air away from the ink as the ink flows toward the second end of the conduit.

### BRIEF DESCRIPTION OF THE DRAWINGS

FIG. 1 is a diagram showing a printhead and related elements of a marking system in accordance with the prior art.

FIG. 2 illustrates elements of an ink pump that exists in the prior art and that may be used in embodiments of the marking system described in this document.

FIG. 3 illustrates modifications that may be made to a marking system to remove air bubbles in accordance with the present disclosure.

FIG. 4 illustrates additional modifications that may be made to a marking system to remove air bubbles in accordance with a first embodiment in the present disclosure.

FIG. 6 illustrates a process of removing air bubbles from a marking system using the embodiment of FIG. 4 or 6.

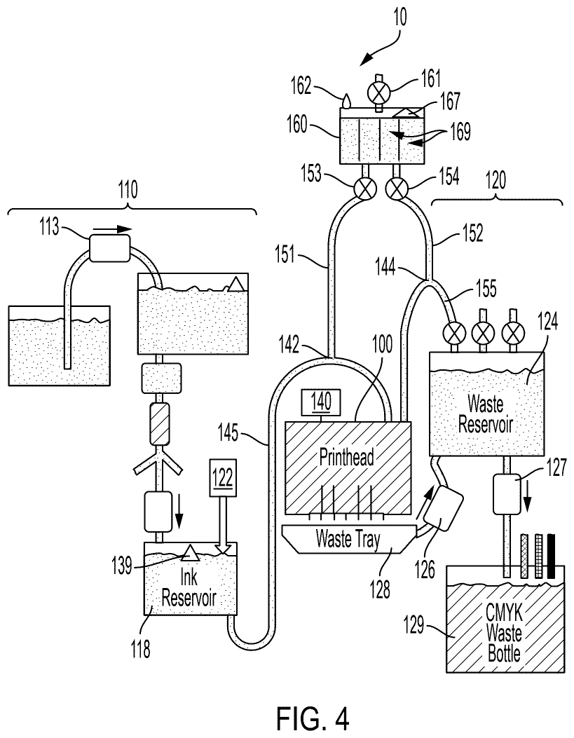

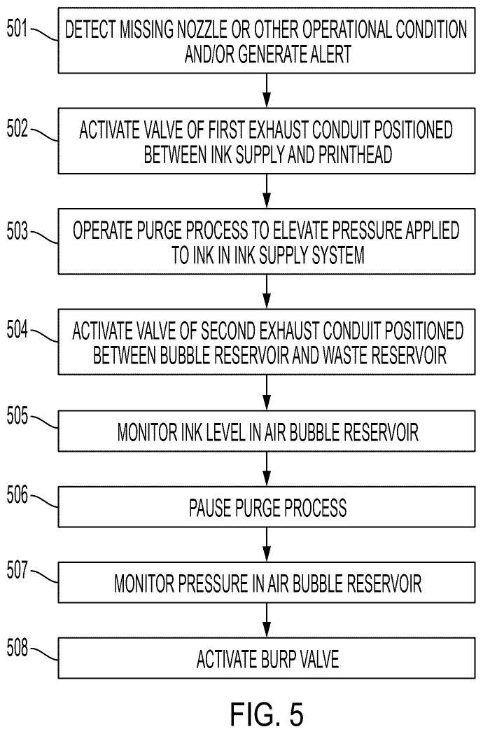

FIG. 4 illustrates additional modifications that may be made to a marking system to remove air bubbles in accordance with a first embodiment in the present disclosure.

FIG. 7 illustrates additional modifications that may be made to a marking system to remove air bubbles in accordance with a second embodiment in the present disclosure.

FIG. 8 illustrates a process of removing air bubbles from a marking system using the embodiment of FIG. 7.

### DETAILED DESCRIPTION

In the various embodiments, the devices, methods and systems of the present disclosure relate to marking systems of printers that include printheads. Specifically, the present disclosure relates to methods, systems, and parts of printheads and ink delivery systems. As discussed above, a common issue occurs with nozzles of printheads and contaminants affecting nozzles. For example, air bubbles can clog ink delivery systems blocking nozzles and affecting print quality (e.g., streaks and lines, color inconsistencies, increased ink usage, etc.). Moreover, such issues often require a service technician, which can be time consuming and, in some cases, costly. The present disclosure relates to a marking system with improved components and systems for rejuvenating missing jets.

As discussed in this document, the term marking system refers to the elements of a printer that deliver inks to a substrate, including the printhead(s) and components that deliver ink to the printhead(s). A printer may include an outer housing that stores the marking system and includes a user interface which allows a user to interact with the system. Color printers typically have multiple printheads. As housings and user interfaces of printers are well known, the present disclosure mainly focuses on marking systems and improvements thereof.

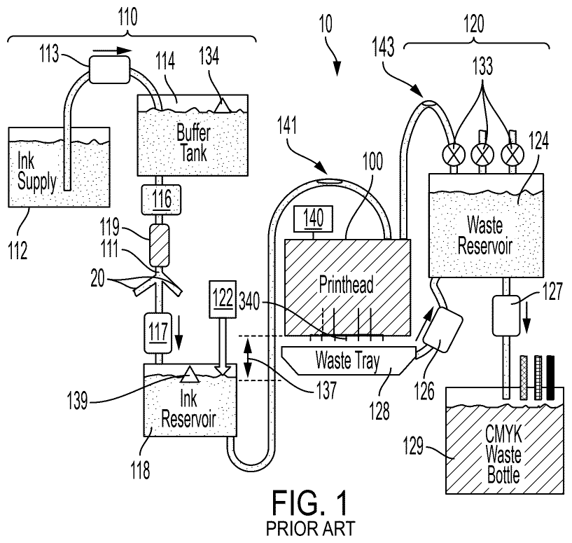

Referring to FIG. 1, elements of a prior art marking system 10 are depicted. The marking system includes a printhead 100, an ink supply system 110, and a waste system 120. The printhead 100 includes hundreds, and in some cases, thousands of small nozzles 340 that are responsible for ejecting ink and creating images on the surface of a medium. The ink supply system 110 provides ink from one or more ink sources to the printhead 100. The waste system 120 manages and removes excess ink, debris and contaminants from the printhead 100. The marking system 10 also includes a control system 140. The control system 140 includes a microcontroller or processor with embedded software and/or a memory containing software that is configured to enable the control system 140 to control the operations of the marking system 10 and its components.

The ink supply system 110 includes an ink supply 112, a buffer tank 114, a filter 116 and degasser 119, and an ink reservoir 118. The ink supply system 110 additionally includes a first ink supply pump 113 and a second ink supply pump 117. The first ink supply pump 113 is positioned in a conduit between the ink supply 112 and buffer tank 114, and during operation it is configured to draw and transport ink from the ink supply 112 to the buffer tank 114. The second ink supply pump 117 is positioned in a conduit 111 between buffer tank 114 and the ink reservoir 118, and it is positioned to draw and transport ink from the buffer tank 114, through the filter 116 and degasser 119, to the ink reservoir 118.

In some embodiments, the buffer tank 114 is the main ink source during use of the marking system 10. It holds ink that is available for immediate use by the printhead 100. The buffer tank 114 may include an ink level detection sensor 134 that can determine whether the marking system 10 requires more ink for proper operation. For example, the ink level detection sensor 134 may include floats, optical sensors, electrical resistance sensors, pressure sensors, or other suitable mechanisms.

In some embodiments, the buffer tank 114 includes separate containers which hold different ink colors. Similarly, multiple ink supplies 112 of different colors may be provided, and multiple ink reservoir 118 compartments may be included. To simplify the system, a single conduit and a single pump are depicted as fluidly interconnecting these elements. However, in practice multiple branches may connect these elements. For example, several branches 20 of conduit 111 may lead various colors of ink out of the tank 114 is attached to separate branches 20. The branches 20 may lead to other ink pumps, ink reservoirs and components discussed hereinafter. For example, in some embodiments, the buffer tank 114 may fluidly be attached to three branches 20 with separate ink pumps, and printheads that make up a marking system. It will be appreciated that there may be more, or fewer, branches 20 in the system and connected to the same or different printheads 100 to form the marking system 10.

The ink supply 112 may be a bottle, a tank, cartridge, ink stick, or other container, typically of a size larger than the size of a corresponding container of the buffer tank 114, to provide a reserve of ink that is used to replenish ink levels in the buffer tank 114 which the levels are below a threshold. In some embodiments that are high volume systems, the ink supply 112 may include a continuous ink supply system with one or more in tanks that are positioned outside of the marking system 10. In some embodiments, when the ink level sensor 134 determines that the buffer tank 114 is low on ink. When the buffer tank 114 is low on ink, the ink supply 112 may be switched to a full ink supply without stopping operation of the marking system 10 as the buffer tank 114 is separate from the ink supply 112.

As discussed above, the buffer tank 114 is fluidly attached to a filter 116 and/or degasser 119 that are positioned to filter and degas the ink before the ink reaches the ink reservoir 118. As depicted, the filter 116 and degasser 119 are arranged prior to (i.e., upstream of) fluid traveling through the second ink supply pump 117 and various branches 20. It will be appreciated that the filter 116 and degasser 119 may be positioned at other locations in the conduit, such as after (i.e., downstream of) the second ink supply pump 117. The filter 116 is configured to remove impurities from the ink prior to the ink reaching ink reservoir 118 and the printhead 100. The filter 116 may be a membrane filter, a fibrous filter, a mesh filter, or a different type of appropriate filter for removing impurities. In some embodiments, the degasser 119 may be configured as a membrane that allows air particles to be pulled through while routing the ink towards the ink reservoir 118. The degasser 119 may also remove other dissolved gases or undissolved gases from the ink prior to the ink reaching the printhead 100. As discussed above, the degasser 119 may be a membrane degasser in some embodiments. In other embodiments, the degasser 119 may also be a vacuum degasser, an ultrasonic degasser, or other degasser.

The ink moves fluidly through the ink delivery system 110 through the second ink supply pump 117. The second ink supply pump 117 fills the ink reservoir 118. The top of the volume of ink in reservoir 118 is positioned below the face of the printhead 100, thus applying a negative pressure at the print head nozzles. A negative pressure is required to form a meniscus (e.g., a curved surface of liquid ink at the opening of the printhead) in the nozzle, which prevents the nozzles from drooling ink during normal operation.

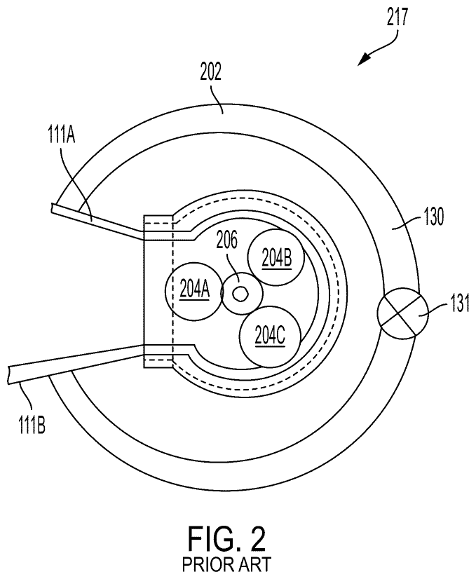

In some embodiments, one or more of the ink supply pumps (such as second ink supply pump 117) may be a peristaltic pump. Referring to FIG. 2, a schematic diagram of a peristaltic pump 217 is shown. The peristaltic pump 217 includes a housing 202, rollers 204A-204C, and a rotor 206 which the rollers 204A-204C rotate about. FIG. 2 also depicts a first conduit segment 111A transporting ink from the buffer tank (114 in FIG. 1) to the peristaltic pump 217 and second conduit segment 111B extending out of the peristaltic pump 217 towards the ink reservoir 118. Each of the conduit segments 111A, 111B is configured as a malleable tubing that resiliently deforms. Ink transports from the first conduit segment 111A to second conduit segment 111B through positive pressure generated by the rollers 204A-204C deforming the tubing and creating kinks as the rollers 204A-204C rotate about the rotor 206. In this manner, ink is transported through the pump 217 as the rotor 206 rotates the rollers and kinks the tubing when rotor 206 seizes movement. In this manner, the peristaltic pump 217 acts as a point where ink stops flowing when not in use. Although a peristaltic pump is shown by way of illustration, other pumps may also be used such as diaphragm pumps, piston pumps, rotary lobe pumps, or a different suitable pump.

Returning to FIG. 1, the second ink supply pump 117 (which may be peristaltic pump 217 of FIG. 2) is positioned at an elevation that is lower than that of the buffer tank 114. The ink reservoir 118 is positioned at an elevation that is lower than that of the buffer tank 114 and the second ink supply pump 117. With this configuration, gravity helps to pull ink from the buffer tank 114 towards the second ink supply pump 117 and the ink reservoir 118.

The ink reservoir may be positioned below the nozzles of the printhead to provide a negative pressure 137 which prevents ink from drooling out of the nozzles in the printhead 100 under normal operating conditions. Alternatively, a pump may apply a vacuum to the air cavity above the ink in the ink reservoir 118 to hold the ink in the reservoir 118 and restrain it from leaking to the printhead 110.

The ink reservoir 118 is additionally attached to a purge pump 122. The purge pump 122 allows for pressure to be placed on the ink in the ink reservoir. This pressure causes ink to flow through the printhead, removing contaminants. Additionally, the purge pump 122 may cause initial ink flow from the reservoir 118 to the printhead 100. The printhead 100 includes ink nozzles that through which the printhead 100 ejects droplets of ink. The ink is periodically pushed through the nozzles using the purge pump 122 to clear contaminants or dried ink to prepare the nozzles for printing.

In some embodiments, the printhead may be a piezoelectric printhead in which each nozzle includes, or groups of nozzles include, one or more piezoelectric elements attached to a diaphragm. Each piezoelectric element changes shape or size when an electric field is applied to it. During operation, the control system 140 causes a voltage to be applied to the piezoelectric material, causing the piezoelectric element to deform. Each cycle of the voltage waveform will cause the piezoelectric material to expand toward the nozzle 340, which increases pressure and causes the meniscus of ink at the nozzle's tip to bulge outward, eventually ejecting the ink. The deformation causes pressure to build on the diaphragm, which causes ink to be ejected from the nozzle 340 under a controlled pressure. The cycle will then cause the piezoelectric element to contract away from the nozzle 340, which helps stop the ink flow and immediately refill the chamber.

In other embodiments, instead of using piezoelectric elements, the printhead may include one or more heating elements that create vapor bubbles, which may expand and contract as the heater changes thermal conditions in the printhead. This expansion and contraction of the vapor bubbles alternatively pushes the ink through the nozzles and causes the flow of ink to stop in a manner that is similar to that implemented by printheads that use piezoelectric elements.

In operation, purge cycles can purge ink through the printhead 100, after which ink is collected via the waste system 120. This process can help extend the life of the marking system 10 and help to remove air bubbles from the system.

Returning to FIG. 1, during a purge cycle, the waste ink is directed into the waste system 120 to allow for storage and proper disposal. The waste system 120 may include a waste tray 128, a waste reservoir 124, a waste bottle 129, and first and second waste transport pumps 126, 127. The waste tray 128 may be positioned under nozzles of the printhead 100 and serve as an initial collection point of ink and may receive ink during purge cycles or other operations where ink needs to be disposed of. The waste tray 128 is fluidly connected to the waste reservoir 124 and transfers ink thereto via a conduit with assistance from the first waste transport pump 126. Optionally, the waste reservoir 124 also may be additionally connected directly to the printhead 100 via one or more conduits 133. The printhead 100 transfers ink directly to the waste reservoir 124 during a manifold purge. A manifold purge is used to move large volumes of fluid through the print head. This is primarily done to change the fluid type in the printhead, remove air from the ink lines or when debugging a problem that cannot be resolved by a normal purge. The waste reservoir 124 may be fluidly attached to other printheads via the conduits 133. In FIG. 1, two additional conduits 133 are depicted. In some other examples, more or fewer conduits may be fluidly attached to the waste reservoir 124.

The waste reservoir 124 serves as a temporary holding tank and is fluidly attached to the waste bottle 129. The waste bottle 129 receives all the unused, or excess ink from the printer during operation and may be periodically changed or emptied during usage. The ink may be transferred to the waste bottle 129 from the waste reservoir 124 via a conduit with assistance from the second waste transport pump 127. The waste bottle 129 is typically larger than the waste reservoir 124 to reduce the frequency of changing the waste bottle 124.

Due to the complexities of the marking system 10, small contaminants such as air bubbles may enter the system during normal operation. Bubbles can form in printheads from air ingestion, cavitation, temperature changes, or other normal operations. In some cases, removal of the contaminants is possible through standard operation of the purge system 120. In some other cases, additional steps are required to remove contaminants.

However, purge cycles, in some cases, are unable to prevent or remove all air bubbles, and additional procedures are often required. As discussed above, when air bubbles 141 form in the ink supply system 110, the air bubbles 141 can rise and build up at the apex of the tubing, and the purge process can miss removing these bubbles. In addition, if air bubbles 143 are purged to the waste system 120, the purge process can draw those air bubbles 143 back into the printhead.

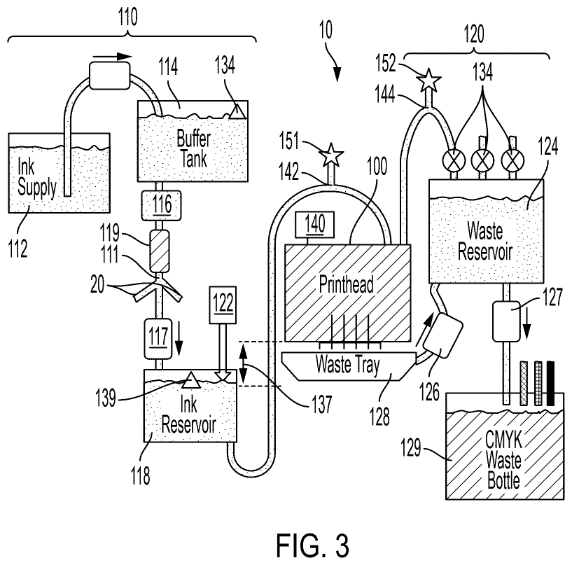

To address this, the marking system may be modified to enable removal of air bubbles directly from the apex of tubing in the ink supply system. For example, FIG. 3 illustrates that the modifications may include fluidly connecting a first exhaust conduit 151 to the apex 142 of the tubing in the ink supply system 110. The apex 142 is the highest point of the tubing between the ink reservoir 118 and the printhead 100 and is the location where air bubbles are most likely to collect in the ink supply system 110. In addition or alternatively, the modifications also may include fluidly connecting a second exhaust conduit 153 to the apex 144 or another point of the tubing in the waste system 120. The apex 144 is the highest point of the tubing between the printhead 100 and the waste reservoir 124 and is the location where air bubbles are most likely to collect in the waste system 120. The first and second exhaust conduits may be fluidly connected to other components, such as those that will be described below.

FIG. 4 illustrates a first embodiment of additional modifications that may be made to a marking system that includes exhaust conduits as in FIG. 3. As shown in FIG. 4, the tubing in the ink supply system 110 includes an ink supply conduit 145, which at its apex 142 has an opening that fluidly connects the ink supply conduit 145 to a first end of the first exhaust conduit 151. The ink supply conduit 145 includes a first end connected to a bottom section of the ink reservoir 118, a second end connected to a the printhead 100, and an intermediate segment that fluidly connects the first end and the second end and in which the apex 142 and corresponding opening are positioned above the printhead 100.

The first exhaust conduit 151 includes a first valve 153 that is positioned at or above the apex 142 and opening. The first valve 153 may be of a type that includes a Luer fitting, a T-port, or another configuration that can selectively allow and or restrict flow. The second end of the first exhaust conduit 151 is fluidly connected to an air bubble reservoir 160 that collects ink and air bubbles that rise through the first exhaust conduit 151 and first valve 153. The air bubble reservoir 160 is positioned above the printhead 100, tubing 145 and exhaust conduit 151 to receive ink and air bubbles that rise through exhaust conduit 151 when the first valve 153 is opened. The air bubble reservoir 160 also may include an exhaust component such as a burp valve 161 located at or near the top of the air bubble reservoir 160 through which air may be exhausted when pressure in the air bubble reservoir 160 increases. The air bubble reservoir also may include a pressure and/or ink level detection component 167 that enables the system or a human operator to determine when to open the burp valve and release pressure in the air bubble reservoir 160, limit pressure from increasing in the reservoir 160, and/or allow air to exit the reservoir, thus making room for ink to enter the reservoir 160. The detection component 167 may be an electromechanical component such as a float sensor or pressure sensor that provides measured data to the system's processor 140 or to display that may be viewed by an operator. Alternatively or in addition, the detection component 167 may be a camera and/or sight glass that provides a human operator with an image or live view of the ink level in the reservoir.

In FIG. 4, a waste ink conduit 155 is fluidly connected to the printhead 100 and waste reservoir 124 directs waste ink from the printhead 110 to the waste reservoir 124 during a purge process. A second exhaust conduit 152 includes a second valve 154 and fluidly connects the bubble reservoir 160 to an opening at the apex 144 of the waste ink conduit 155. The air bubble reservoir 160 is also positioned above the second exhaust conduit 152, waste ink conduit 155 and waste reservoir 124. When the second valve 154 is opened, ink may flow from the air bubble reservoir 160 to the waste reservoir 124. Although FIG. 4 illustrates first valve 153 and second valve 154 as two separate valves, in some embodiments they may be combined into a single component such as a T-port valve that selectively enables flow to be directed from (i) the first exhaust conduit 151 to the bubble reservoir 160 or (ii) from the bubble reservoir 160 to the waste reservoir 124, in which case “activating the first valve” means positioning the T-port valve to enable flow in direction (i), and “activating the second valve” means positioning the T-port valve to enable flow in direction (ii). Optionally, with a T-port valve, both valves may be activated, and both flows enabled, at the same time.

In configurations with multiple printheads, multiple air bubble reservoirs or vacuum sources may be used, or multiple exhaust conduits (one for each ink color) may direct air from the ink supply conduits of each color to a single air bubble reservoir or vacuum source. If so, then optionally, as shown in FIG. 4, the air bubble reservoir 160 may include multiple sub-chambers 169, each of which receives ink from an individual ink color supply, with separate level sensors, and/or a sight glass and camera configured to reveal any differences in levels of each type of ink. This can help the system or an operator identify which printheads are relatively more responsible, or relatively less responsible, for air bubbles in the overall marking system. In addition, in some embodiments each chamber may include its own dedicated burp valve 161. The chambers 169 may be completely isolated from each other, or they may be separated by dividing walls with an open top as is shown in FIG. 4.

In addition, in some embodiments, instead of a separate air bubble reservoir 160 and waste reservoir 124, the waste reservoir 124 of waste system 120 may be positioned above the printhead 100, and if so the waste reservoir 124 may also serve as the air bubble reservoir.

FIG. 5 is a process flow diagram illustrating a method of removing air bubbles from a marking system using components such as those shown in FIG. 4. The marking system includes an air bubble reservoir 160 and a first valve 153 positioned in a conduit between the ink supply and the printhead. The first valve 153 is normally closed to maintain the negative hydrostatic pressure in the printhead that is caused by the printhead being located above the ink reservoir 118. At step 502, activating the first valve 153 opens the first valve 153, and thus opens a flow path from the first exhaust conduit 151 to the bubble reservoir 160. This allows air bubbles from ink that is flowing toward the printhead to rise in the first exhaust conduit 151 so that the air bubbles pass through first valve 153 and into the air bubble reservoir 160. The air bubbles may displace some ink in the air bubble reservoir, and that ink will return to the system via the first exhaust conduit 151.

Optionally, concurrently with opening the valve, and also optionally before opening the valve, at 503 a purge process is applied to the marking system to apply pressure to the ink delivery system and expel ink from the printhead. The purge process may be implemented by activating the purge pump 122 and/or other methods that increase pressure on the ink. The purge process can further help push the air bubbles up into the exhaust conduit and into the bubble reservoir.

Optionally, the valve may be activated at step 502 and purge process triggered at step 503 in response to detecting a missing nozzle condition or other printer operational condition (step 501) as described earlier in this document, with the activation being manually initiated by an operator in response to receiving an alert generated by the processor, or automatically initiated by the processor in response to detecting the condition.

As noted in the discussion of FIG. 1, during operation air bubbles 143 also may form at the apex 144 (see FIG. 4) of a waste ink conduit 155 in the waste system 120. To eliminate these air bubbles 143, at 504 the second valve 154 also may be opened during the purge process, which cases waste system air bubbles 143 to be drawn into the bubble reservoir 160.

At some point, the air bubble reservoir 160 will become substantially filled with ink. As noted above, the bubble reservoir may include a detection component such as a float sensor, camera, and/or sight glass that is used to monitor the ink level in the reservoir (step 505). Optionally, when the ink level reaches at least a threshold height in the reservoir, at 506 the processor or a human operator may pause the purge process, such as by stopping operation of the purge pump. This allows ink to drain from the air bubble reservoir 160 back to the ink reservoir 118. Alternatively, the valve 154 of the second exhaust tube 152 may be opened at the same time that the valve 153 of the first exhaust tube is opened so that ink flows to the waste reservoir 124.

At some point, air pressure in the reservoir may increase to the point of requiring relief. As noted above, the bubble reservoir's detection component may include a pressure sensor that is used to monitor pressure in the air bubble reservoir (step 507). When the pressure in the bubble reservoir reaches at least a threshold level, at 508 the processor or a human operator may activate the burp valve 161 to open. This allows air to be expelled from the air bubble reservoir 160 to atmosphere, which relieves and reduces pressure in the air bubble reservoir 160. If partial walls are used to separate the ink chambers 169 in the reservoir as shown in FIG. 4, the burping may allow ink to rise in the reservoir until it overflows the walls of the dividers and resets the ink levels in all chambers to a common level.

The process described above may be repeated over multiple times, alternated with a purge process, and/or alternated with printing of one or more test sheets to determine print quality.

In some embodiments, instead of or in addition to burp valve 161, a location at or near the top of the air bubble reservoir 160 may include a very small opening 162 that remains open at all times to provide a passage that allows air to enter and exit the air bubble reservoir 160. The opening 162 can thus help the air pressure in the reservoir to remain close to ambient air pressure. The opening 162 will have a very small diameter to minimize evaporation. Optionally, the opening may be included in or connected to a tube that passes through the air bubble reservoir's housing, and the opening may include a filter that prevents dust particles from entering into the air bubble reservoir 160.

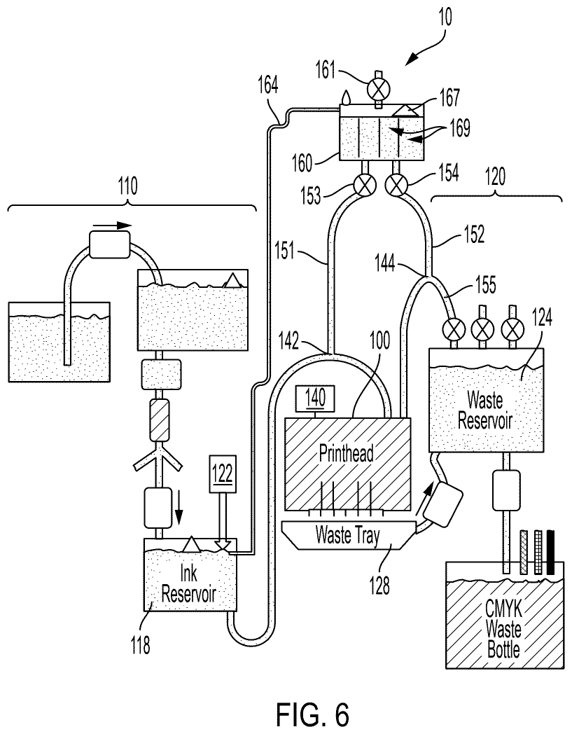

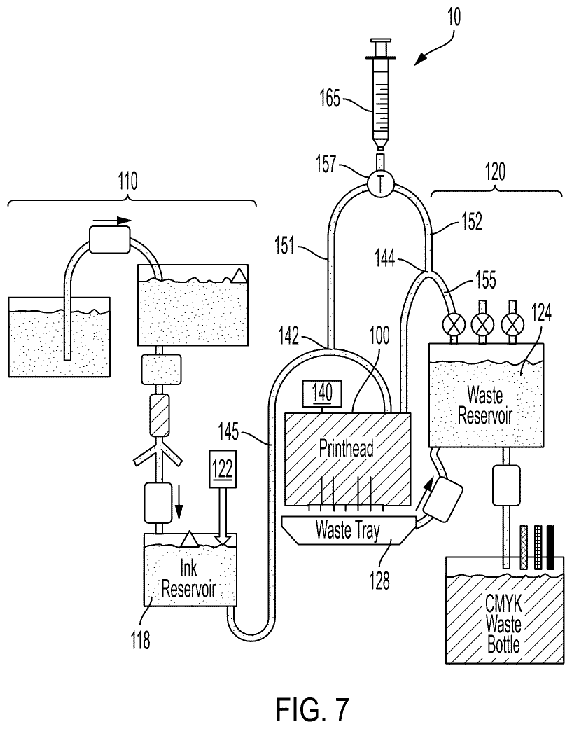

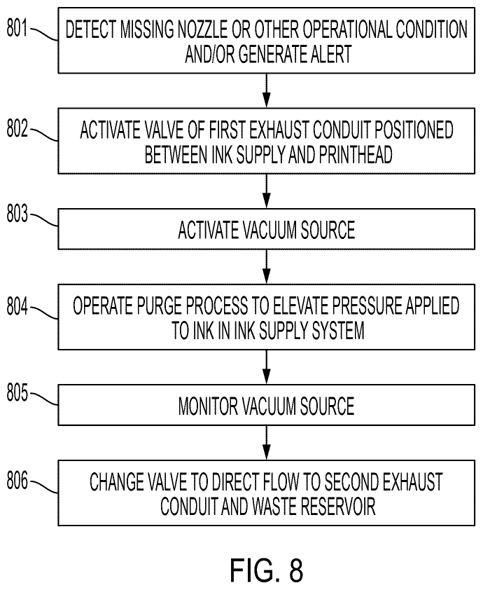

In some embodiments, as illustrated in FIG. 6, in addition to or instead of including a burp valve 161 or opening 162, the air bubble reservoir 160 may include a port from which a drainage conduit 164 extends. The drainage conduit 164 fluidly connects an upper area of the air bubble reservoir 160 to the ink reservoir 118. The port to which the drainage conduit 164 is attached may be positioned on a sidewall of the reservoir at a position above which the ink level should not rise, When the ink level in the reservoir reaches the level of the drainage conduit 164, the ink will start to drain through the conduit and return to the ink reservoir 118. Alternatively, instead of leading to the ink reservoir 118, the drainage conduit 164 could fluidly connect the air bubble reservoir 160 to the waste reservoir 124 and allow the ink to drain to the waste reservoir 124 when the ink reaches the level of the drainage conduit 164 port in the air bubble reservoir 160.

FIG. 7 illustrates an embodiment of additional modifications that may be made to a marking system that includes exhaust conduits as in FIG. 3. Similar to the embodiments of FIGS. 4 and 6, in FIG. 7 the tubing in the ink supply system 110 includes an ink supply conduit 145, which at its apex 142 has an opening that fluidly connects the ink supply conduit 145 to a first end of the first exhaust conduit 151. A valve 157 is positioned at or above the apex 142 and opening. The valve 157 is configured to receive the inlet portal of a vacuum source 165 such as a syringe. The valve 157 may be of a type that includes a T-port, an injection cap, or another configuration that can selectively allow and or restrict flow to the vacuum source 165. When the valve 157 is open and vacuum source 165 is activated, air bubbles that rise through first exhaust conduit 151 will be drawn into vacuum source's inlet portal. For example, if the vacuum source 165 is a syringe, when the syringe's plunger is retracted through the syringe's barrel away from the syringe's inlet portal, a vacuum will draw air and ink through the valve 157 and into the chamber of the syringe's barrel.

In FIG. 7, a second exhaust conduit 152 is also connected to the valve 157 and fluidly connects the valve 152 to the opening at the apex 144 of the waste conduit 155. In addition, if valve 157 is a three-way valve in which the direction of flow may be selectively changed to (a) block ink flow, (b) direct ink flow from the first exhaust conduit 151 to the vacuum source 165, or (c) direct ink flow from the vacuum source 165 to the second exhaust conduit 151, the valve 157 may be set to permit the vacuum source 165 to dispense ink from its chamber to the waste reservoir 124.

FIG. 8 is a process flow diagram illustrating a method of removing air bubbles from a marking system using components such as those shown in FIG. 5 or 6. The marking system includes a vacuum source 165 and a valve 157 positioned in a conduit between the ink supply and the printhead. The valve is normally closed to maintain the negative hydrostatic pressure in the printhead that is caused by the printhead 100 being located above the ink reservoir 118. At step 802, activating the valve 157 opens the valve, and thus opens a flow path from the first exhaust conduit 151 to the vacuum source 165. At 803 the vacuum source is activated, such as (in the case of a syringe) by withdrawing the plunger away from the valve and creating a vacuum in a chamber in syringe's barrel. This removes the negative pressure from the printhead and instead applies negative pressure to the tubing of the ink supply system, which withdraws air bubbles from ink that is flowing toward the printhead in the first exhaust conduit 151 so that the air bubbles (and optionally some ink) pass through valve 157 and into the bubble reservoir 160.

Optionally, concurrently with opening the valve, and also optionally before opening the valve, at 804 a purge process is applied to the marking system to apply pressure to the ink in the ink delivery system and expel ink from the printhead. The purge process may be implemented by activating the purge pump 122 and/or other methods of increasing pressure on the ink. The positive pressure applied to the exhaust tube by the purge process can further help push the air bubbles up into the exhaust conduit and into the bubble reservoir.

Optionally, the valve may be activated at step 802 and purge process started at step 804 in response to detecting a missing nozzle condition or other printer operational condition (step 801) as described earlier in this document, with the activation being manually implemented by an operator in response to receiving an alert generated by the processor, or automatically implemented by the processor in response to detecting the condition.

As noted in the discussion of FIG. 1, during operation air bubbles 143 also may form at the apex 144 (see FIG. 4) of a waste ink conduit 155 in the waste system 120. To eliminate these air bubbles 143, at 806 the second valve 154 also may be opened during the purge process, which cases waste system air bubbles 143 to be drawn into the bubble reservoir 160.

The process described above may be repeated over multiple times, alternated with a purge process, and/or alternated with printing of one or more test sheets to determine print quality.

Optionally, the processes described in this document (such as those illustrated in FIGS. 6 and 8) may be implemented after a normal purge process has been run. For example, when a threshold number of nozzles are not functioning properly as determined by the control system, such that the quality of printing is affected, the control system may signal to the user or the system that a purge cycle should be ran, or a purge cycle may be ran through automation. The purge pump and/or other pumps of the system will increase the pressure and flow rate of the ink running through the printhead during the purge operation. If the missing jet condition has not been cleared by the purge system after a threshold period of time, or after a threshold number of purge cycles have been run, the system may activate the valves to direct air bubbles to a bubble reservoir or vacuum source as described in this document. In addition, in some embodiments the system may alternate cycles in which one or more purge procedures are run, then one or more bubble exhaust procedures. The cycles may continue for a set number of cycles, for a set period of time, or until the missing jet condition is resolved.

Detection of the missing nozzle condition may occur by the control system 140 in response to a missing jet measurement. For example, the missing jet measurement may be accomplished by causing the marking system 10 to print a document and measuring the number of nozzles that are missing as discussed above. If the number of missing nozzles is above a threshold number, the system may prompt a user to trigger the purge protocol and/or bubble exhaust protocol.

Optionally, other conditions can trigger the bubble exhaust procedure. For example, the control system may be programmed to trigger a purge procedure automatically upon the system reaching a threshold operational condition, such as when the printhead has printed a threshold number of sheets since the last bubble exhaust, when the printhead has consumed a threshold amount of ink since the last bubble exhaust, or detection of other faults in the system. After the standard purge is completed one or more times, the system may then initiate the bubble exhaust procedure if the missing jet condition has not yet resolved. In other embodiments, activating the bubble exhaust procedure may comprise generating a visual and/or audible prompt that invites a user to manually start the exhaust protocol. In other examples, the exhaust procedure may be started manually by an operator. For example, the exhaust procedure may be initiated by the operator in response to system faults or issues identified by the operator.

It will be appreciated that the above examples may be used in systems with multiple printheads. For example, a typical printer may include three separate printheads. In typical printers, printheads must be purged simultaneously. In some cases, contaminants occur in all printheads, and flushing ink through all of the printheads is beneficial. However, in some cases, blockages or contaminants occur in only one printhead. Thus, the above methods also may be used only in a single printhead or multiple printheads. In configurations with multiple printheads, multiple air bubble reservoirs or vacuum sources may be used, or multiple exhaust conduits (one for each ink color) may direct air from the ink supply conduits of each color to a single air bubble reservoir or vacuum source.

The term “approximately,” when used in connection with a numeric value, is intended to include values that are close to, but not exactly, the number. For example, in various embodiments, the term “approximately” may include values that are within +/−1% of the value, +/−5% of the value, +/−10 percent of the value, or any value or fraction thereof between any or all of the values. The term “substantially,” when used in connection with a numeric value, is intended to mean approximately, within a threshold tolerance that is a percentage corresponding to any of the percentages described in the previous sentence.

In this document, the term “fluidly connected” means, with respect to two or more components, that a path exists between the components via which a fluid may flow from one of the components to the other, either directly or through one or more intermediary components.

This disclosure is not limited to the particular systems, methodologies or protocols described, as these may vary. The terminology used in this description is for the purpose of describing the particular versions or embodiments only and is not intended to limit the scope. It will be understood that terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to emphasize this meaning, unless the context or other statements clearly indicate otherwise. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances. The term “substantially” may be used to encompass this meaning, especially when such variations do not materially alter functionality.

Thus, as described above, this document describes various structures and methods that may be employed to help remove undesirable air bubbles from the ink supply components of a printer or similar marking system. These structures and methods are illustrated by the following clauses:

Clause 1: A method of removing air from an ink supply of a marking system, the method comprising activating a valve that is fluidly connected to an ink supply system of a marking system. The valve is fluidly positioned in a conduit that leads from an opening in a conduit of the ink supply system to an air bubble reservoir. Activating the valve withdraws air from ink in the conduit as the ink moves toward a printhead of the marking system.

Clause 2: The method of clause 1 further comprising, concurrently with activating the valve, operating a purge process in the marking system to elevate pressure applied to the ink in the ink delivery system and expel ink from the printhead.

Clause 3: The method of clause 1 or 2, wherein the valve is fluidly connected to an apex of a conduit that directs the ink toward the printhead, and the apex is located above the printhead.

Clause 4: The method of any of clauses 1-3, further comprising activating a second valve that is fluidly positioned in a second conduit that leads from the air bubble reservoir to a waste ink system that includes a waste reservoir so that air bubbles in the waste ink system rise through the second conduit to the air bubble reservoir.

Clause 5: The method of any of clauses 1-4 further comprising, in response to detecting that pressure in the air bubble reservoir exceeds a threshold or that an ink level in the air bubble is below the threshold, activating a burp valve to allow some of the air to exhaust from the air bubble reservoir through the burp valve.

Clause 6: The method of any of clauses 1-5, wherein activating the valve comprises applying a vacuum to the conduit through an opening of the valve.

Clause 7: The method of any of clauses 1-6, wherein activating the valve comprises applying a tip of a syringe through an opening of the valve and withdrawing a plunger of the syringe to draw the air into a barrel of the syringe.

Clause 8: The method of clause 7, wherein the valve is fluidly connected to an apex of a conduit that moves the ink toward the printhead, the apex is located above the printhead, and the conduit directs the ink toward the printhead after the air is directed toward the valve.

Clause 9: The method of clause 2, wherein operating the purge process and activating the valve are initiated automatically, by a processor of the marking system in response to detecting a missing nozzle condition in the printhead or a threshold operating condition of the marking system.

Clause 10: The method of clause 2 further comprising, before operating the purge process and activating the valve: by a processor of the marking system, generating an alert in response to detecting a missing nozzle condition in the printhead, wherein operating the purge process and activating the valve are initiated in response to the alert.

Clause 11: A marking system, comprising a printhead comprising a plurality of nozzles configured to eject ink from the printhead onto a substrate, and an ink supply system configured to supply ink to the printhead. The ink supply system comprises an ink supply reservoir configured to hold the ink for delivery to the printhead. The marking system also comprises a first conduit comprising a first end fluidly connected to a bottom section of the ink reservoir, a second end fluidly connected to the printhead, and an intermediate segment that (a) fluidly connects the first end and the second end, and (b) has an apex that is positioned above the printhead. The apex is fluidly connected to an exhaust conduit that is configured and positioned to, during operation, receive air from the ink and convey the air away from the ink as the ink flows toward the second end of the conduit.

Clause 12: The marking system of clause 11, wherein the exhaust conduit is fluidly connected to an air bubble reservoir.

Clause 13: The marking system of clause 12, wherein the air bubble reservoir includes a burp valve or opening for exhausting the air from the air bubble reservoir.

Clause 14: The marking system of clause 12 or 13, further comprising a waste tray positioned to receive waste ink output by the nozzles, and a waste reservoir fluidly connected to the waste tray, wherein the air bubble reservoir is also fluidly connected to a waste ink system to deliver ink from the waste ink system to the air bubble reservoir.

Clause 15: The marking system of any of clauses 11-14, wherein the exhaust conduit comprises a valve that is positioned at or above the apex.

Clause 16: The marking system of clause 15, wherein the valve comprises a Luer fitting, a T-port valve, or an injection cap.

Clause 17: The marking system of clause 15 or 16, further comprising a vacuum source that is fluidly connected to the valve to draw the air through the valve.

Clause 18: The marking system of clause 15 or 16, further comprising a pressure source that is positioned to apply pressure to the ink in the first conduit before the ink reaches the valve.

Clause 19: The marking system of any of clauses 15-18, further comprising a waste tray positioned below the printhead to receive waste ink output by the nozzles, and a waste reservoir fluidly connected to the waste tray, wherein the valve is also fluidly connected to the waste reservoir to deliver additional ink to the waste reservoir.

Clause 20: The marking system of any of clauses 11-19, further comprising a plurality of additional printheads and a plurality of additional ink supply conduits configured to supply ink of different colors to the additional printheads. The marking system also comprises a plurality of additional exhaust conduits, each of which is connected an apex of one of the additional printheads and positioned to, during operation, receive air from the ink of different colors and convey that air to the air bubble reservoir.

Clause 21: The marking system of clause 20, wherein the air bubble reservoir comprises a plurality of chambers, each of which is fluidly connected to one of the exhaust conduits to receive ink of a single color from its connected exhaust conduit.

It will be understood that various modifications may be made to the embodiments disclosed in this document. Likewise, the above disclosed methods may be performed according to an alternate sequence. Therefore, the above description should not be construed as limiting, but merely as examples of the various embodiments. Those skilled in the art will envision other modifications within the scope and spirit of the claims appended to this document.

1. A method of removing air from an ink supply of a marking system, the method comprising:
activating a valve that is fluidly connected to an ink supply system of a marking system, wherein the valve is fluidly positioned in a conduit that leads from an opening in a conduit of the ink supply system to an air bubble reservoir;
wherein activating the valve withdraws air from ink in the conduit as the ink moves toward a printhead of the marking system.

2. The method of claim 1 further comprising, concurrently with activating the valve, operating a purge process in the marking system to elevate pressure applied to the ink in the ink delivery system and expel ink from the printhead.

3. The method of claim 1, wherein:
the valve is fluidly connected to an apex of a conduit that directs the ink toward the printhead; and
the apex is located above the printhead.

4. The method of claim 1, further comprising activating a second valve that is fluidly positioned in a second conduit that leads from the air bubble reservoir to a waste ink system that includes a waste reservoir so that air bubbles in the waste ink system rise through the second conduit to the air bubble reservoir.

5. The method of claim 1 further comprising, in response to detecting that pressure in the air bubble reservoir exceeds a threshold or that an ink level in the air bubble is below the threshold, activating a burp valve to allow some of the air to exhaust from the air bubble reservoir through the burp valve.

6. The method of claim 1, wherein activating the valve comprises applying a vacuum to the conduit through an opening of the valve.

7. The method of claim 1, wherein activating the valve comprises:
applying a tip of a syringe through an opening of the valve and withdrawing a plunger of the syringe to draw the air into a barrel of the syringe.

8. The method of claim 7, wherein:
the valve is fluidly connected to an apex of a conduit that moves the ink toward the printhead;
the apex is located above the printhead, and
the conduit directs the ink toward the printhead after the air is directed toward the valve.

9. The method of claim 2, wherein operating the purge process and activating the valve are initiated automatically, by a processor of the marking system in response to detecting a missing nozzle condition in the printhead or a threshold operating condition of the marking system.

10. The method of claim 2 further comprising, before operating the purge process and activating the valve:
by a processor of the marking system, generating an alert in response to detecting a missing nozzle condition in the printhead, wherein
operating the purge process and activating the valve are initiated in response to the alert.

11. A marking system, comprising:
a printhead comprising a plurality of nozzles configured to eject ink from the printhead onto a substrate;
an ink supply system configured to supply ink to the printhead, the ink supply system comprising:
an ink supply reservoir configured to hold the ink for delivery to the printhead, and
a first conduit comprising:
a first end fluidly connected to a bottom section of the ink reservoir,
a second end fluidly connected to the printhead, and
an intermediate segment that fluidly connects the first end and the second end, and that has an apex that is positioned above the printhead,
wherein the apex is fluidly connected to an exhaust conduit that is configured and positioned to, during operation, receive air from the ink and convey the air away from the ink as the ink flows toward the second end of the conduit.

12. The marking system of claim 11, wherein the exhaust conduit is fluidly connected to an air bubble reservoir.

13. The marking system of claim 12, wherein the air bubble reservoir includes a burp valve or opening for exhausting the air from the air bubble reservoir.

14. The marking system of claim 12, further comprising:
a waste tray positioned to receive waste ink output by the nozzles; and
a waste reservoir fluidly connected to the waste tray,
wherein the air bubble reservoir is also fluidly connected to a waste ink system to deliver ink from the waste ink system to the air bubble reservoir.

15. The marking system of claim 11, wherein the exhaust conduit comprises a valve that is positioned at or above the apex.

16. The marking system of claim 15, wherein the valve comprises a Luer fitting, a T-port valve, or an injection cap.

17. The marking system of claim 15, further comprising a vacuum source that is fluidly connected to the valve to draw the air through the valve.

18. The marking system of claim 15, further comprising a pressure source that is positioned to apply pressure to the ink in the first conduit before the ink reaches the valve.

19. The marking system of claim 15, further comprising:
a waste tray positioned below the printhead to receive waste ink output by the nozzles; and
a waste reservoir fluidly connected to the waste tray,
wherein the valve is also fluidly connected to the waste reservoir to deliver additional ink to the waste reservoir.

20. The marking system of claim 11, further comprising:
a plurality of additional printheads;
a plurality of additional ink supply conduits configured to supply ink of different colors to the additional printheads; and
a plurality of additional exhaust conduits, each of which is connected an apex of one of the additional printheads and positioned to, during operation, receive air from the ink of different colors and convey that air to the air bubble reservoir.

21. The marking system of claim 20, wherein the air bubble reservoir comprises a plurality of chambers, each of which is fluidly connected to one of the exhaust conduits to receive ink of a single color from its connected exhaust conduit.
